(19) United States
(12) Patent Application Publication
(10) Pub. No.: US 2021/0326893 A1
(43) Pub. Date: Oct. 21, 2021

(54) Universal Intelligent Module For Communications, Transactions, and Payments

(71) Applicant: Pierre Stevens, Delray Beach, FL (US)

(72) Inventor: Pierre Stevens, Delray Beach, FL (US)

(21) Appl. No.: 16/851,065

(22) Filed: Apr. 16, 2020

(51) Int. Cl. G06Q 20/40; G06Q 20/32

(52) U.S. Cl. CPC G06Q 20/40145; G06Q 20/3278

(57) ABSTRACT

An onboard secure activation module that adds smart device functionality to a variety of devices that do not have smart device functionality. The onboard secure activation module can be attached to a cellular phone, a watch, a watch wristband, a bracelet, jewelry, a key FOB, or other portable device. In addition, the universal intelligent module can also be incorporated into any portable item. The invention enables any non-smart cellular phone, bracelet, watch, item of jewelry. or key FOB, be it vintage or otherwise, to become a smart device. The onboard secure activation module contains all the components necessary for applications such as payments, identification, authentication, and/or other applications. Further, the universal intelligent module can be secured to any existing wristband, or other device can have its functionality expanded as new applications and functions become available.

### CROSS-REFERENCE TO RELATED APPLICATIONS

This Continuation-in-Part application is related to, and claims the benefit of, the co-pending provisional patent application entitled “Universal Intelligent Communications, Device”, filed Nov. 13, 2015, bearing U.S. Ser. No. 62/255,337 and naming Pierre Stevens, the named inventor herein, and Bernard Stevens, as joint inventors, the co-pending non-provisional patent application entitled “Universal Intelligent Module For Communications, Transactions, and Payments”, filed Jan. 27, 2016, bearing U.S. Ser. No. 15/008,380 and naming Pierre Stevens, the named inventor herein, and Bernard Stevens, as joint inventors, the contents of which is specifically incorporated by reference herein in its entirety.

### BACKGROUND

### Technical Field

This invention relates in general to communications, transaction, and payment devices. In particular, it relates to an intelligent converter module that can provide any watch or bracelet, either new or antique, into a device that has the functionality of a smart watch. It provides a communications function that can be an integral part of, or attached to, a personal accessory such as a bracelet or wristwatch. In particular, the invention extends “smart watch” capability to a variety of items such as conventional watches, antique watches, bracelets, etc.

### Background of the Invention

This invention provides the ability to add the functionality of modern smart phones to older “non-smart” phones that may have little or no capability beyond traditional voice phone calls, as well as other devices, such as jewelry, etc. Likewise, it would be desirable to be able to add additional functionality as new applications are developed.

More recently, a new class of device has been developed, namely, the “Smart Watch.” For example, the iWatch™, which is commercially available from the Apple corporation, along with other similar devices. The technology used by this watch allows the user to perform many of the functions provided by Smart phones. This improves usability by providing an individual with a very compact and easy to transport device that can perform many functions heretofore not available. As was the case above, the new functionality available in high-tech Smart Watches is not available to individuals using conventional or older wristwatches. It would be desirable to have a method of extending these functions to older watches that have limited or no functionality aside from telling time.

In addition to cell phones and watches, there are a number of individuals who wear jewelry items such as bracelets. Currently, conventional bracelets are typically worn as jewelry, and sometimes provide limited functions such as medical alert bracelets that have engraved information regarding the wearer's medical conditions. While these devices perform the functions for which they were designed, they do not provide any of the information or communication services that have become commonplace with smart phones. It would be desirable to make this functionality available to wearers of bracelets.

Further, the current classes of intelligent devices are limited in that they provide a limited level of security for users wishing to use these devices for personal or financial activities. For example, prior art intelligent devices often store important codes, such as pin activation codes in remote servers. This exposes the user to potential harm because a user's private information can be obtained by hackers if they attack the servers. It would be desirable to have a more secure way to protect user information such that only the user can make payments or other transactions.

An additional drawback associated with all of the foregoing prior art “Smart” devices is security. Typically when accessing remote services, such as banking or other financial services, individuals access those services by entering security codes such as pin numbers. There is a security exposure to users using these systems because the servers used by the remote services often have copies of the pin numbers to verify that an authorized user is conducting transactions. This is a problem in that there is a security exposure in the event that hackers access the remote server to gain access to a users pin number. It would be desirable to have a system wherein the user had sole access to the pin number with no copies replicated in other sites.

A problem associated with all of the prior art devices is that their use can lead to exposure of information, such as passwords, or information stored on conventional credit card magnetic stripes. It would be desirable to have a way of using portable devices to conduct transactions without risking exposure to unauthorized parties having access to the information needed to initiate and complete a transaction.

While the prior art has provided solutions for newly manufactured devices, such as Smart watches and Smart phones it has not provided any functional improvements to older or simpler devices that were not fabricated with the communications or functional capabilities of the current categories of intelligent devices. The invention provided herein extends the functionality of Smart phones to older non-smart phones as well as conventional wristwatches and bracelets. In addition, the invention provides additional security features to isolate pin numbers.

### SUMMARY OF THE INVENTION

This invention provides an intelligent accessory that provides communications functionality to devices that have no such functionality. The invention can convert any conventional non-smart cell phone, watch, bracelet, or key FOB to an intelligent communications device by attachment of an Onboard Secure Activation Module (“OSAM”). The OSAM can be implemented in two embodiments: 1) as a PAM (a PIN Activated Module), or 2) as a BAM (a Biometric Activated Module). Of course the OSAM can include both embodiments. The OSAM is attached to a cell phone, watch, bracelet, key FOB or other portable device. In addition, the OSAM can also be incorporated into other portable items that an individual may carry. The invention enables any cell phone, watch, bracelet, key FOB, or other small portable device, be they vintage or otherwise, to become an intelligent device capable of communicating, and performing a variety of transactions, including financial transactions. The OSAM contains all the components necessary to satisfy the requirements of the different applications for which it is intended, be it payments, identification, authentication, or many other applications. Further, the OSAM can be incorporated into any small portable device that an individual may carry, such that even what is today only available in a smart watch can have its functionality extended to older devices, and further have the capability to incorporate new applications and functions as they become available.

### BRIEF DESCRIPTION OF THE DRAWINGS

FIG. 1 is a flowchart showing the data flow using the OSAM.

FIG. 2 illustrates an OSAM attached to a prior art cell phone.

FIG. 3 illustrates an OSAM attached to a prior art cell phone cover.

FIG. 4 illustrates an OSAM used with a prior art wristwatch band.

FIG. 5 illustrates an OSAM incorporated into a wristwatch band.

FIG. 6 illustrates an OSAM attached to a prior art bracelet.

FIG. 7 illustrates an OSAM incorporated into a bracelet.

FIG. 8 illustrates an OSAM attached to a prior art key FOB.

FIG. 9 illustrates an OSAM attached to a prior art key FOB cover.

FIG. 10 illustrates an OSAM incorporated into a key FOB.

FIG. 11 is a flowchart of a preferred embodiment of the OSAM that uses biometric activation.

FIG. 12 is a flowchart of an alternative preferred embodiment of the OSAM that uses pin code activation.

### DETAILED DESCRIPTION OF THE PREFERRED EMBODIMENT

The invention is an independent module that accepts, powers, activates, and incorporates different optional communication and transactional sub-modules that can be attached to a wristband carrying a high-end or other watch thus transforming the watch to an intelligent watch. The independent module may also be attached to any other device, such as a cell phone, key FOB, or bracelet. The invention provides secure access to external systems for conducting financial and other transactions, without requiring conventional devices, such as magnetically striped credit cards.

An important advantage provided by the invention is the creation of a new medium of data exchange that overcomes the security issues plaguing a variety of communications devices, such as Near Field Communications (NFC) equipped telephones and point-of-sale (POS) devices. NFC utilizes a RF electromagnetic field as a carrier of transactional information. Security concerns arising from the ease of intercepting NFC transmissions carrying sensitive transactional data, as well as other security issues, have necessitated the development of a new technology that will replace NFC's weakest link: radio frequency (RF) transmission.

For improved security, the invention uses a Spatial Proximity Transaction System (SPTS) that utilizes diffused infra frequency (infrared) waves of medium-energy elementary particles (Quantum Field Theory) of photons or a blue laser to transmit transactional data thereby defeating any unauthorized attempts to intercept and capture said data by RF receivers. SPTS acts as a substitute carrier, accepting, transmitting and receiving the same data as those typically transmitted through NFC; however, SPTS is not part of the common radio wave spectrum and thus cannot be intercepted by any easily obtained RF reader. SPTS can be integrated into a mobile phone, a smart card, a smart acoustic card, a wristwatch, a bracelet, a FOB, a POS device, etc. The system's proprietary diffusion arrangement will permit spatial transmission allowing the waving of a mobile phone or others similarly equipped object toward a device to initiate or complete a transaction.

In the preferred embodiment, SPTS technology is incorporated into an integrated circuit chip that will in turn be incorporated into devices for use with mobile phones, POS devices, etc.

For ease of discussion, a preferred embodiment of the invention uses a “PIN Activated Universal Intelligent Module” (PAM). The PAM provides a code-dependent enabling and time-dependent disabling chip functionality. As a result, only the authorized user can activate the chip embedded in the watch or the wristband. The PAM is enabled by its user's introduction of his PIN number on onboard keys or dial input. Thus, the PIN is not stored on a server, but stored in the PAM as a means to strictly reserve access to the authorized user only.

The PAM uses entry keys, dials, or any other suitable means to enter data. The PAM responds to the user's input of a valid PIN number by activating the embedded chip. The information provided for authentication and proper user verification resides in a memory that is insulated from an external attack. In the preferred embodiment, the PAM will, by the use of the keys or the dial, generate the required information to be enabled for a predetermined duration before being disabled. The duration of the activation is limited to the programmed time necessary to complete a transaction and can be programmed by its user. The time limitation provides a disabling function for the PAM that inhibits its use by unauthorized parties. As a result, if an unauthorized user came into possession of a lost or stolen watch, the watch cannot be used by the unauthorized user because the user would not have the information necessary to complete a transaction. The PAM improves security because only the individual that knows the PIN can use the watch for transactions.

The previous embodiment discusses the invention in terms of a watch. However, the PAM is not limited to use with a watch, but can be used in conjunction with a wide variety devices such as a cellular phone, a bracelet, a wristwatch band, an attachment to a wristwatch band, etc. As a result, those skilled in the art will realize that the invention is not limited to that category of accessories illustrated herein. While the technology disclosed herein can be integrated into a smart watch, it can also be used to:

1. Upgrade an existing smart watch by incorporating new features into the watch's wristband.

2. Incorporating new features into a clip or sleeve that attaches to a pre-existing wristband.

3. Incorporating the new features into a bracelet.

4. Incorporating new features into a clip or sleeve that attaches to a pre-existing bracelet period.

5. Upgrading a key FOB.

6. Incorporating the Invention into covers for Devices such as cell phones, wristwatches, or key FOBs

Having discussed the invention in general, we turn now to a discussion of the figures.

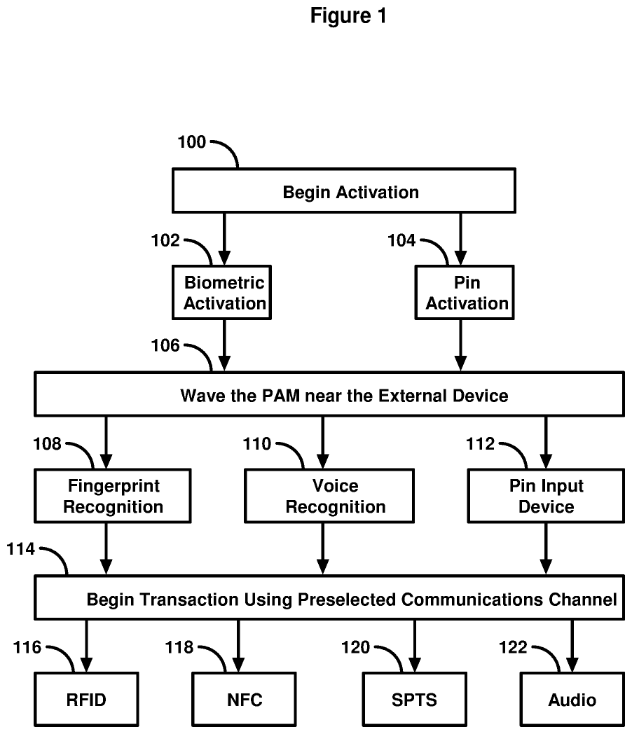

FIG. 1 is a flowchart showing the basic data flow of the invention. For ease of discussion, the term OSAM will be used to describe a universal intelligent module that provides new functionality to a watch, a wristband, a bracelet, key FOB, a cover for any of those devices, or any other small device that a user may wish to use.

In step 100, the user begins activation of the OSAM. The OSAM, if implemented as a BAM can be activated biometrically as shown at step 102, or activated, if implemented as a PAM, via PIN entry as shown in step 104. The general use of both PIN entry and biometric detection are known techniques. Activation can be accomplished by waving the OSAM near an external system, such as a POS device, etc., as shown at step 106. The invention provides improved security because the OSAM must be in close proximity to the external system it will communicate with. Since the only person who owns the OSAM can use it to initiate and complete a transaction, a hacker would not be able to access the owner's information. Once the OSAM detects an external system, it initiates authorization, at steps 108 or 110 using BAM biometric recognition or voice recognition, respectively. Alternatively, the PAM can initiate authorization at step 112 using PIN entry. Once authorized, the OSAM begins a transaction, at step 114, with the external system using a preselected communications channel. The authorization process can be further secured using any of the security features disclosed in U.S. Pat. No. 7,013,393. In the preferred embodiment, communication with the external system is accomplished via NFC Communications at step 118, or via SPTS infrared Communications at step 120. Those skilled in the art will recognize that communication can also be implemented using RFID at step 116, or Audio at step 122.

The OSAM can be personalized via a Nano SIM card supplied by the financial institution that secures the financial transaction, or by a credit card issuing bank.

Both the OSAM (if necessary) and the Nano SIM card can be powered by a wireless rechargeable battery. Wireless rechargeable batteries are well known in the art. In addition, the OSAM will preferably include a standardized receptacle to accommodate chips from different issuers of NFC, SPTS, RFIS, audio, and/or transport chips. Transport chips are commonly used in fare payment cards by commuters.

The Oyster card used by the London, UK transit system is one example of a transport chip embedded in a credit card shaped fare payment card. The invention expands this technology by providing transport chip technology to the OSAM 9. This allows anyone wearing an OSAM 9 enhanced wristwatch, bracelet, or other OSAM 9 enhanced device to always have access to their fare payment card. Preferably, the transport chip is either integrated into the OSAM 9, or is a separate chip that can be inserted into the OSAM 9. The advantage of a separate transport chip that can be inserted into the OSAM 9 is that, when an individual moves to a new locale, they can easily replace the transport chip with one that is designed to work with the transportation system at that location. Further, the transport chip can be attached to a device, such as a wristwatch band, a bracelet or one of the other devices discussed herein, and work independently from other functions in the OSAM. It can be attached as a circuit installed in the OSAM 9 or as a separate circuit with a sleeve, a pocket in the users Device, as shown in the following figures.

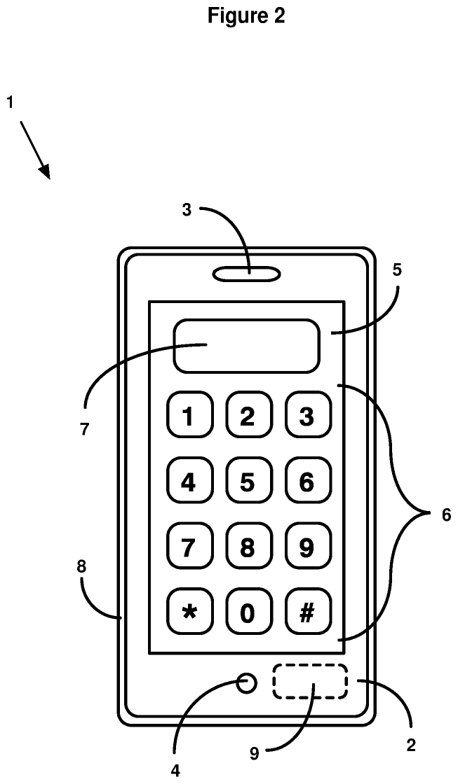

FIG. 2 illustrates an OSAM 9 attached to a prior art cell phone 1. The OSAM 9 can be attached directly to the cell phone 1 via any suitable means, such as adhesives, clamps, wristband sleeves, etc. Likewise, it can be attached to a conventional removable cell phone 1 case for a prior art cell phone. The OSAM 9 is shown in dashed lines to indicate that it can be internal to the cell phone 1, or located on the front or rear of the cell phone. Also shown are cell phone 1 components, including the cell phone case 2, the cell phone speaker 3, the cell phone microphone 4, and the front panel 5 that holds the data entry keyboard 6 and the display screen 7. External cover 8 is also shown.

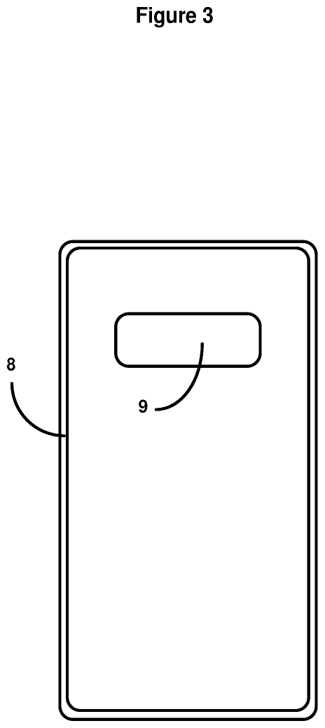

FIG. 3 illustrates an OSAM 9 attached to the external cover 8 of a prior art cell phone 1. This embodiment also allows the OSAM 9 to provide advanced functions to users of prior art cell phones 1 through the simple process of attaching the OSAM 9 to a conventional cell phone case 8. Once attached, the OSAM 9 allows even phones with no intelligence to be used as communication devices.

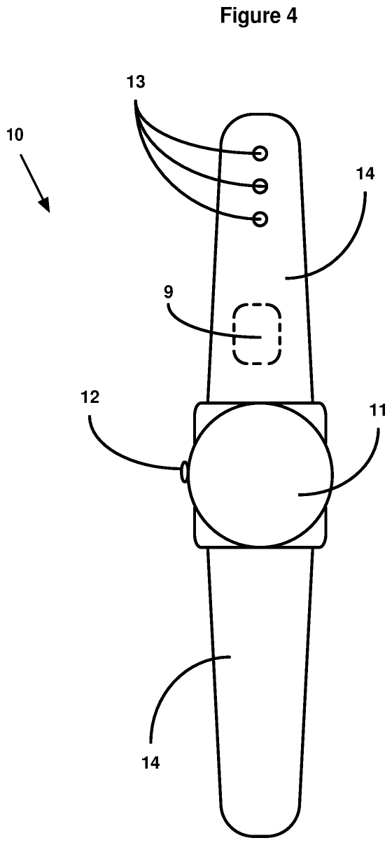

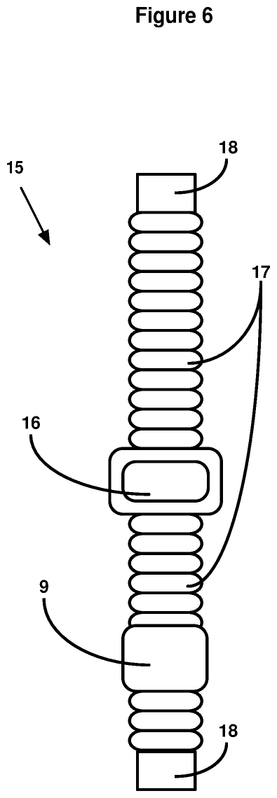

FIG. 4 illustrates a wristwatch 10 with an OSAM 9 integrated into a wristwatch band 14. In this figure, the OSAM 9 is integrated with the wristwatch band 14 during the fabrication process. If the watch 11 is replaced, the user can move the wristwatch band 14 to the new watch 11 and thereby transfer the functionality of the OSAM 9. Those skilled in the art will realize that the OSAM 9 can also be integrated with a sleeve that fits around the wristwatch band 14 in the same manner as the OSAM 9 sleeve used by the bracelet 15 shown in FIG. 6 An advantage of fabricating the OSAM 9 in a sleeve configuration is that the OSAM 9 can be easily transferred from one wristwatch band 14 to another. As a result, configuring the OSAM 9 in a sleeve configuration allows the OSAM 9 to be used with any wristwatch 10, or even with other devices such as a bracelet 15.

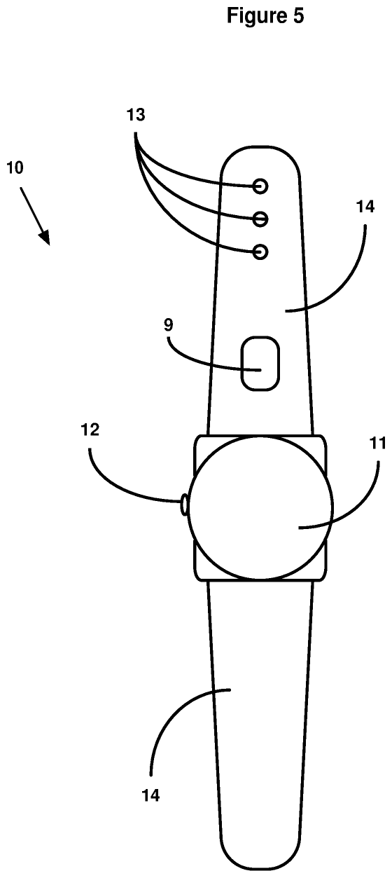

FIG. 5 illustrates an OSAM 9 Incorporated into a wristwatch band 14. In this preferred embodiment, the OSAM 9 is physically incorporated into the wristwatch band 14. This may be done when the original wristwatch 10 is fabricated, or the OSAM 9 may be incorporated into a replacement wristwatch band 14, or secured to a preexisting wristwatch band 14. When the OSAM 9 is incorporated into the wristwatch band 14 it provides an advantage in that it is invisible to the casual observer. When used as a sleeve that is placed over a wristwatch band 14, it may be more noticeable, however, it also allows the OSAM 9 to be easily moved from one wristwatch band 14 to another.

FIG. 6 illustrates an OSAM 9 attached to a prior art bracelet 15. The bracelet 15 has straps 17 that connect to an optional ornamental item 16 such as a gemstone, etc. Of course, the ornamental item 16 can be dispensed with and a single strap 17 can be used. The straps 17 each have clasps 18 on their distal ends that secure together when the bracelet 15 is worn. OSAM 9 is shown as a sleeve that slides over strap 17. When used with a bracelet 15, the OSAM 9 is secured to the bracelet in the same manner that it would be secured to a wristwatch band 14. During use, the user would merely wave the bracelet 15 near an external system to begin activation as discussed above. Alternatively, the OSAM 9 could be integrated into the bracelet 15, for example, by concealing it in the ornamental item 16.

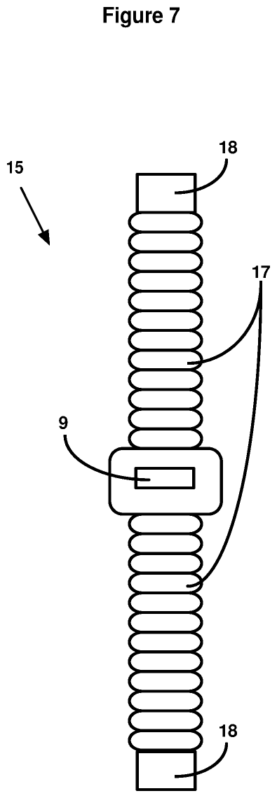

FIG. 7 illustrates an OSAM 9 that is an integral part of a bracelet 15. An advantage provided when incorporating the OSAM 9 into a bracelet 15 during initial manufacturing is that its presence is invisible to a casual observer. This figure shows the OSAM 9 secured to the underside of the bracelet 15. By securing the OSAM 9 in this manner, it can be used in conjunction with older bracelets 15. As a result, even an antique bracelet 15 can have the functionality heretofore available only from smart devices. Of course, its activation process will be the same as that shown above in regard to FIG. 6.

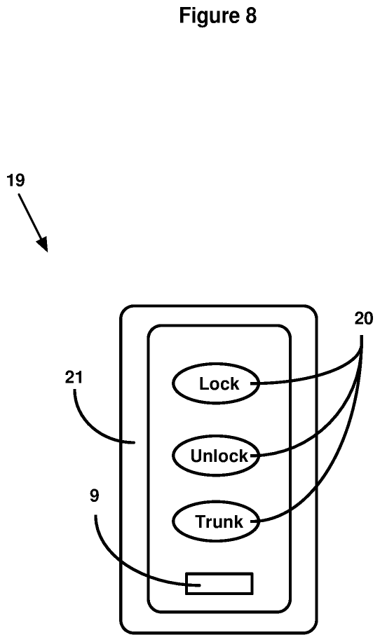

FIG. 8 illustrates another preferred embodiment in which the OSAM 9 is used in conjunction with a conventional key FOB 19, such as those used by automobiles. In this figure, the OSAM 9 is secured to a prior art key FOB 19. This can be done in any convenient manner, such as adhesives, etc. Those skilled in the art will recognize that the OSAM 9 can alternatively be incorporated into the electronics in the key FOB 19 such that it is invisible to a casual observer. The figure also illustrates the typical input keys 20 used by a key FOB, and the key FOB cover 21.

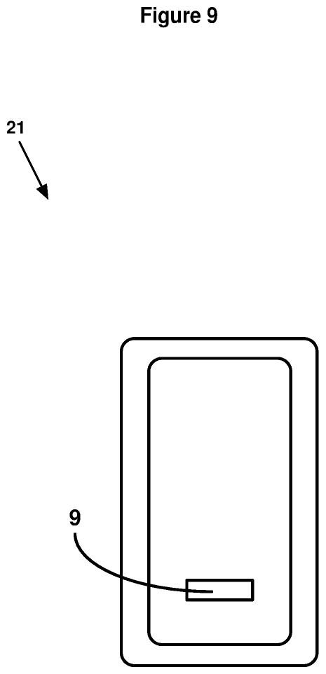

FIG. 9 illustrates an alternative preferred embodiment in which an OSAM 9 is attached to a prior art key FOB cover 21. By securing the OSAM 9 to the key FOB cover 21, the OSAM 9 can be used as an after market feature with any key FOB 19 and does not have to be manufactured as an original component of the key FOB 19.

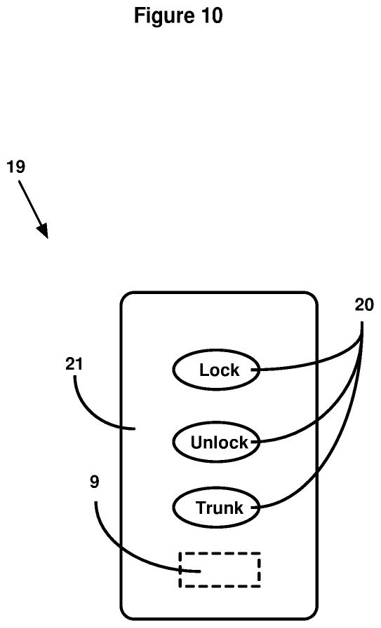

FIG. 10 illustrates another alternative embodiment in which an OSAM 9 is an integrated component of a key FOB 9. In this embodiment, the OSAM 9 is not visible to the casual observer.

An advantage of the OSAM 9 is that it can be activated by a variety of methods. For example, it addition to the pin, discussed above, it can have a biometric activation, such as a fingerprint detector, voice recognition, etc. Whether pin activated or biometrically activated, the OSAM 9 then activates the NFC transaction chip or the infrared transaction chip, or both. As a result, only an authorized user can activate the OSAM 9.

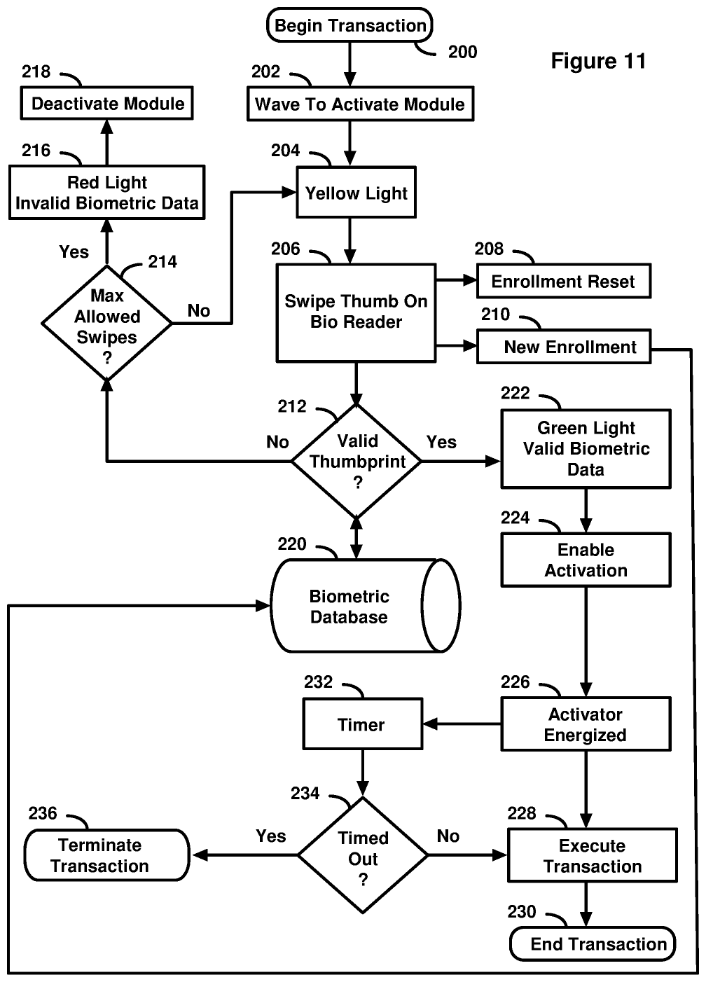

FIG. 11 is a flowchart of a preferred embodiment of the invention that uses biometric activation. At step 200, the user initiates a transaction. At step 202 the user activates the OSAM 9 by waving it in proximity to an external system. When the OSAM 9 is activated by a response from the external system, it notifies the user at step 204. For ease of discussion, a yellow light is used at step 204 to alert the user that the OSAM 9 is waiting for biometric data input. Those skilled in the art will realize that while a light is used to indicate that the OSAM 9 is waiting for biometric input, the user could also be notified in alternative ways, such as audio, or even a display screen on an external system, such as a gasoline pump.

At step 206, the user enters the biometric data. In the figure, the OSAM uses fingerprint data entered by swiping the user's thumb across an integral biometric reader. If an OSAM 9 is being reset for use or if it is being transferred to a new user, the user will reset the OSAM 9 at step 208. In step 210, if an OSAM 9 is being initially activated for use, or activated for a new user, the entry of biometric data will initiate enrollment and the biometric data will be recorded in the biometric database 220.

If the OSAM 9 is not being reset or if a new enrollment is not being made, the OSAM 9 will compare the entered biometric data with the stored biometric data in the biometric database 220. The entered biometric data is determined to be invalid at step 214, the OSAM 9 will allow successive entries via steps 204, 206, 212 up to a predetermined limit (for example, 3 tries). If the maximum allowed number of swipes are exceeded at step 214, the OSAM 9 indicates at step 216 that invalid biometric data has been exceeded, and the OSAM module is deactivated at step 218.

At step 212, when the OSAM 9 determines that valid biometric data has been entered, it gives an optional indication at step 222 and enables activation of a transaction at step 224. At step 226, the activation of the transaction with an external system begins. When the transaction is activated at step 226, the transaction with the external system begins at step 228. At the same time the activation of the transaction begins at step 226, a timer in the OSAM 9 is started at step 232. The time measured by the timer is compared to a predetermined time limit at step 234. If the time limit is exceeded, the transaction is terminated at step 236. If the time limit is not exceeded, the transaction with the external system is completed at step 228 and the transaction ends at step 230.

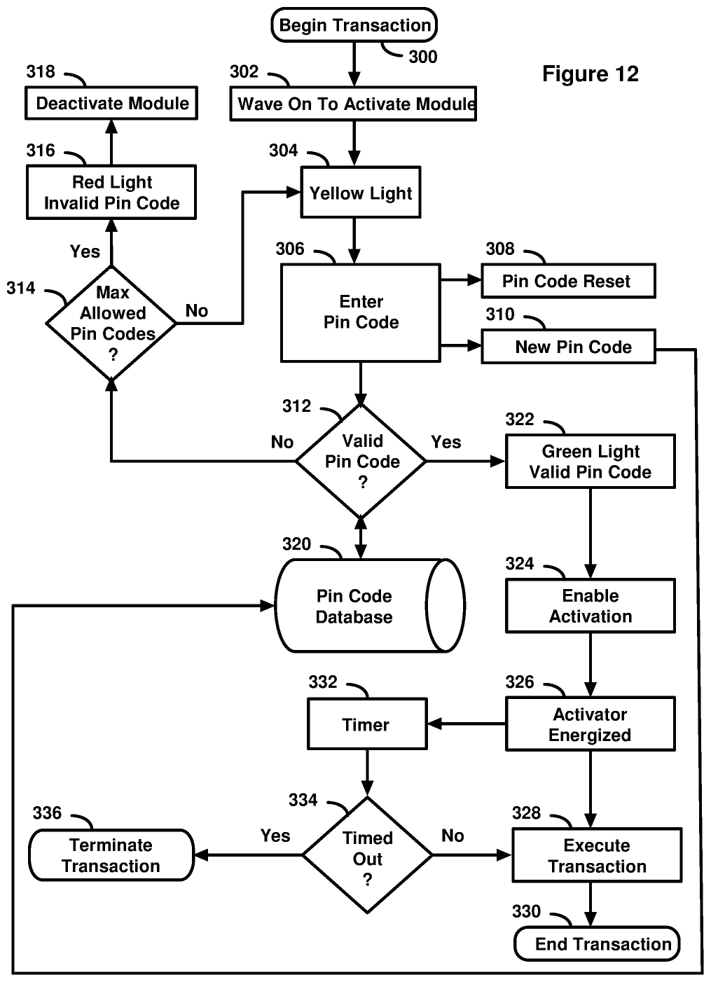

FIG. 12 is a flowchart of an alternative preferred embodiment of the invention that uses pin code activation. At step 300, the user initiates a transaction. At step 302 the user activates the OSAM 9 by waving it in proximity to an external system. When the OSAM 9 is activated by a response from the external system, it notifies the user at step 304. For ease of discussion, a yellow light is used at step 304 to alert the user that the OSAM is waiting for pin code input. Those skilled in the art will realize that while a light is used to indicate that the OSAM 9 is waiting for pin code input, the user could also be notified in alternative ways, such as audio, or even a display screen on the external system, such as an ATM machine.

At step 306, the user enters the pin code data. If an OSAM 9 is being reset for use or if it is being transferred to a new user, the user will reset the OSAM 9 at step 308. At step 310, if an OSAM 9 is being initially activated for use, or activated for a new user, the entry of pin code data will initiate enrollment and the pin code data will be recorded in the pin code database 320.

If the OSAM 9 is not being reset, or if a new enrollment is not being made, the OSAM 9 will compare the entered pin code data with the stored pin code data in the pin code database 320. If the entered pin code data is determined to be invalid at step 214, the OSAM 9 will allow successive entries via steps 304, 306, 312 up to a predetermined limit (for example, 3 tries). If the maximum allowed number of pin code entries are exceeded at step 314, the OSAM 9 indicates at step 316 that invalid pin code data has been exceeded, and the OSAM 9 is deactivated at step 318.

At step 312, when the OSAM 9 determines that valid pin code data has been entered, it gives an optional indication at step 322 and enables activation of a transaction at step 324. At step 326, the activation of the transaction with an external system begins. When the transaction is activated at step 326, the transaction with the external system begins at step 328. At the same time the activation of the transaction begins at step 326, a timer in the OSAM 9 is started at step 332. The time measured by the timer is compared to a predetermined time limit at step 334. If the time limit is exceeded, the transaction is terminated at step 336. If the time limit is not exceeded, the transaction with the external system is completed at step 328 and the transaction ends at step 330.

Depending on the nature of the device that the OSAM 9 is attached to, the pin code can be entered in any convenient manner. For example, in the case of a cell phone, the data entry keys on the cell phone may be used, etc. Likewise, a small keypad can be incorporated into the OSAM 9.

Those skilled in the art will realize that the biometric embodiment, and the pin code embodiment, and be implemented by a single OSAM device that allows use with a wider variety of external systems.

While specific embodiments have been discussed to illustrate the invention, it will be understood by those skilled in the art that variations in the embodiments can be made without departing from the spirit of the invention. The types of devices that can implement the invention can vary, the method of attachment can vary, etc. Therefore, the invention shall be limited solely to the scope of the claims.

We claim:

1. An attachable intelligent module for adding communications functionality for devices having no such functionality, comprising:
an onboard secure activation module, the onboard secure activation module further comprising:
data storage for holding biometric identification information related to a user;
a transceiver for communicating with external systems when an authorized user is verified;
a biometric reader for entering biometric data; and
a comparison circuit for comparing biometric identification information in the data storage to the entered biometric data, the comparison circuit preventing transactions with external systems when the entered biometric data is invalid, and allowing transactions with external systems when the entered biometric data is valid;
attachment means for removably attaching the onboard secure activation module to a device;
whereby, devices formerly having no communications capability are given communications capability by attachment of an onboard secure activation module to the device.

2. The attachment means are adhesives, clamps, or wristband sleeves.

3. An onboard secure activation module, as in claim 1, wherein:
the transceiver uses an SPTS NFC, or RFID communication transmitter to communicate with the external system, or the onboard secure activation module uses audio communication transmitters to communicate with the external system; and
the onboard secure activation module is activated when the device it is attached to is waved in proximity to the external system.

4. An onboard secure activation module, as in claim 3, further comprising:
a timer that terminates a transaction with the external system when a predetermined time limit has been exceeded.

5. An onboard secure activation module, as in claim 1, wherein:
the onboard secure activation module is attachable to devices, namely cell phones, cell phone covers, wrist watches, wristbands, bracelets, jewelry, key FOBs, and/or key FOB covers.

6. An onboard secure activation module, as in claim 5, wherein:
the onboard secure activation module is removably attached to devices;
whereby, the onboard secure activation module is movable from one device to another.

7. A method for adding communications functionality to devices having no such functionality, including the steps of:
removably attaching an onboard secure activation module to a device, the onboard secure activation module further including the steps of:
using data storage to hold biometric identification information related to a user; and
using a transceiver for communicating with external systems when an authorized user is verified; and
using attachment means to removably attach the onboard secure activation module to a device;
whereby, devices formerly having no communications capability are given communications capability by attachment of an onboard secure activation module to the device.

8. A method as in claim 7, including the additional steps of:
using a biometric reader for entering biometric data into the data storage; and
using a comparison circuit for comparing biometric identification information in the data storage to the entered biometric data, the comparison circuit preventing transactions with external systems when the entered biometric data is invalid, and allowing transactions with external systems when the entered biometric data is valid.

9. A method, as in claim 7, including the additional step of using adhesives, clamps, or wristband sleeves as the attachment means.

10. A method, as in claim 7, including the additional steps of:
the transceiver communicating with the external system using SPTS NFC, or RFID, or using audio communication transmitters to communicate with the external system; and
the onboard secure activation module is activated when the device it is attached to is waved in proximity to the external system.

11. A method, as in claim 7, including the additional step of terminating the transaction with the external system when a predetermined time limit is exceeded.

12. A method, as in claim 7, including the additional step of attaching the onboard secure activation module to devices, namely cell phones, cell phone covers, wrist watches, wristbands, bracelets, jewelry, key FOBs, and/or key FOB covers.

13. A method, as in claim 7, including the additional step of, removably attaching the onboard secure activation module to devices;
whereby, the onboard secure activation module is movable from one device to another.

14. A method, as in claim 7, including the additional steps of:
entering pin code data using a pin code input;
storing pin code data having biometric identification information related to a user in the data storage;
communicating with external systems when an authorized user is verified; and
using a comparison circuit to compare pin code identification information in the data storage to the entered pin code data, and preventing transactions with external systems when the entered pin code data is invalid.

15. A method, as in claim 7, including the additional step of activating when the onboard secure activation module when it is waved in proximity to the external system.

16. A method, as in claim 7, including the additional step of using a sleeve to attach the onboard secure activation module to wristwatch bands or bracelets.

17. A method, as in claim 7, including the additional step of:
attaching the onboard secure activation module to cell phones, cell phone covers, wrist watches, wristbands, bracelets, key FOBs, and/or key FOB covers with an adhesive.
